(19) United States
(12) Patent Application Publication
(10) Pub. No.: US 2007/0212548 A1
(43) Pub. Date: Sep. 13, 2007

(54) Glazing system with high glass transition temperature decorative ink

(75) Inventors: Christophe Lefaux, Ann Arbor, MI (US); Sunitha Grandhee, Novi, MI (US); Kenneth Foster, Brighton, MI (US)

Correspondence Address: EXATEC;C/O BRINKS HOFER GILSON & LIONE, P. O. BOX 10395, CHICAGO, IL, 60610, US

(73) Assignee: EXATEC LLC

(21) Appl. No.: 11/372,656

(22) Filed: Mar. 10, 2006

(51) Int. Cl. B32B 9/04; B32B 27/36; B32B 27/06

(52) U.S. Cl. 428/411.1; 428/480

(57) ABSTRACT

A plastic glazing system for automotive windows is disclosed. The system comprises a transparent plastic substrate comprising a first surface and a second surface, and a blackout layer disposed on the periphery of the first surface of the substrate. The blackout layer has a predetermined glass transition temperature. The system further comprises an abrasion-resistant layer disposed on the first surface, the abrasion-resistant layer being compatible with the blackout layer.

### TECHNICAL FIELD

The present invention relates to plastic glazing systems having a decorative black out ink with a high glass transition temperature.

### BACKGROUND OF THE INVENTION

For many years, glass has been a component used for windows in the automotive industry. As known, glass provides a level of abrasion resistance and ultraviolet radiation (UV) resistance acceptable to consumers for use as a window in vehicles. Although adequate in that respect, glass substrates are characteristically relatively heavy which translates to high costs in delivery and installment. Moreover, the weight of glass ultimately affects the total weight of the vehicle. Plastic materials have been used in a number of automotive engineering applications to substitute glass, enhance vehicle styling, and lower total vehicle weight and cost. An emerging application for transparent plastic materials is automotive window systems.

Therefore, there is a need in the industry to formulate glass substitute window systems, such as plastic window systems, that are easier to manufacture and relatively lighter in weight without compromising functionality, such as abrasion resistance and UV resistance.

### BRIEF SUMMARY OF THE INVENTION

The present invention generally provides a plastic glazing system and method of manufacturing such system having enhanced yield and efficiency. More specifically, embodiments of the present invention provide a plastic glazing system that is easier to manufacture having relatively lighter weight and higher yield.

In one embodiment, the present invention provides a plastic glazing system for automotive windows. The system comprises a transparent plastic substrate comprising a first surface and a second surface, and a blackout layer disposed on the periphery of the first surface of the substrate. The blackout layer has a predetermined glass transition temperature. The system further comprises an abrasion resistant layer disposed on the first surface. The abrasion resistant layer is compatible with the blackout layer.

In another embodiment, the present invention provides a method of making a plastic glazing system. The method comprises applying a blackout layer on the periphery of a transparent plastic substrate. The blackout layer has a predetermined glass transition temperature. The method further comprises applying an abrasion resistant layer disposed on the blackout layer. The abrasion resistant layer is compatible with the blackout layer.

Further objects, features, and advantages of the present invention will become apparent from consideration of the following description and the appended claims when taken in connection with the accompanying drawings.

### BRIEF DESCRIPTION OF THE DRAWINGS

FIG. 1 is a cross-sectional view of a plastic glazing system depicted in accordance with one embodiment of the present invention; and

FIG. 2 is a graph of the Modulus (E) exhibited by a polymer system versus Temperature depicting the occurrence of a Glass Transition Temperature (Tg).

### DETAILED DESCRIPTION OF THE INVENTION

The present invention generally provides a plastic glazing system having enhanced yield. The plastic glazing system includes a plastic substrate, a blackout layer on a first surface of the substrate, a weathering layer on a second surface thereof, and an abrasion layer on both the blackout and weathering layers. One example of the present invention comprises a vehicle window comprising a plastic glazing system in accordance with the embodiment of the present invention as described above. In this example, the plastic glazing system has enhanced yield including enhanced abrasion resistance and ultraviolet resistance.

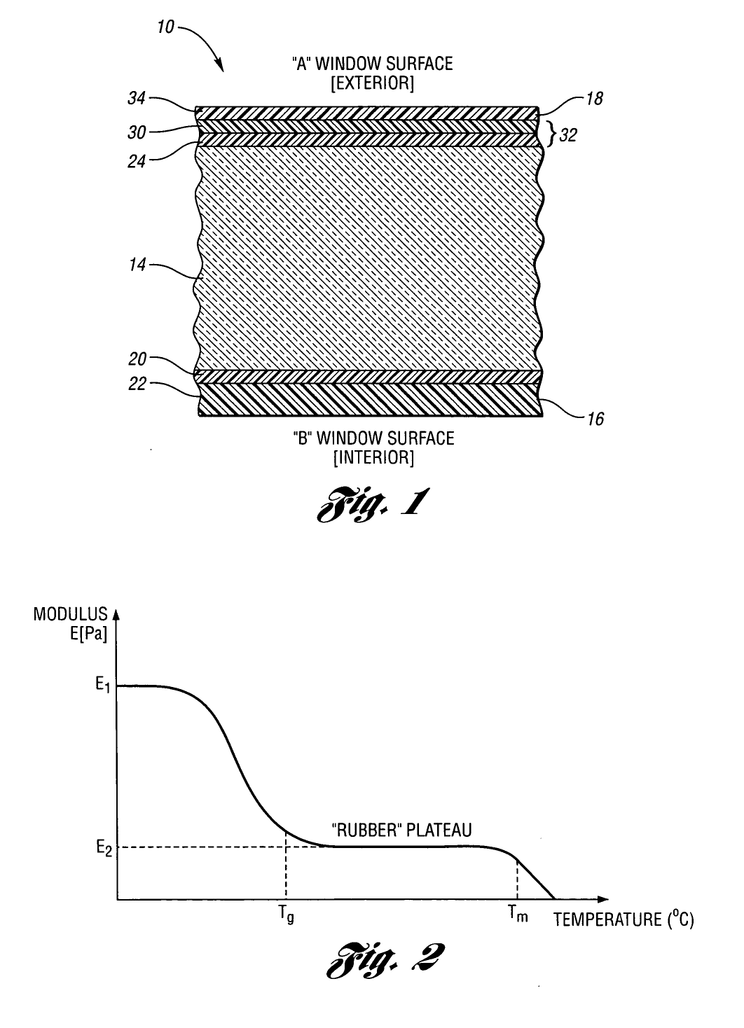

FIG. 1 depicts one example of a cross-section of a plastic glazing system 10. The plastic glazing system 10 is preferably a system for use as automotive windows. As shown, the plastic glazing system 10 includes a transparent plastic substrate 14 having a first surface 16 and a second surface 18. In this embodiment, the second surface 18 is an outer or “A” surface and the first surface 16 is an inner or “B” surface of the window.

In this embodiment, the transparent plastic substrate 14 comprises polycarbonate, acrylic, polyacrylate, polyester, polysulfone resins, blends or copolymers, or any other suitable transparent plastic material, or a mixture thereof. Preferably, the transparent plastic substrate 14 includes bisphenol-A polycarbonate and other resin grades (such as branched or substituted) as well as being copolymerized or blended with other polymers such as polybutylene terephthalate (PBT), Poly-(Acrylonitrile Butadiene Styrene (ABS), or polyethylene. The transparent plastic substrate 14 may further comprise various additives, such as colorants, mold release agents, antioxidants, and ultraviolet absorbers.

As shown in FIG. 1, a blackout layer 20 is disposed on the transparent plastic substrate 14. In this embodiment, the substrate 14 comprises the blackout layer 20 applied on the periphery of the first surface 16 of substrate 14. In this embodiment, the blackout layer 20 is an ink comprising a polyester resin. For example, the polyester ink may comprise a dispersion of a polyester resin mixture, titanium oxide, carbon black, gamma-butyrolactone, aliphatic dibasic acid ester and other colorant pigments in a mixture of various solvents, such as petroleum distillate, cyclohexanone mixture, and naphthalene solvents. In this embodiment, the ink printed and cured on the plastic substrate has a thickness of greater than about 3 micrometers with between about 5 to 8 micrometers being preferred, and has an opacity of greater than about 98% with between 99.8% to 100% being preferred in order to hide any adhesive system used to bond the window to the body of the vehicle. The polyester resin comprises about 17 to 29 weight percent of the polyester ink.

A black-out layer may be defined as a substantially opaque print applied to the substrate for decorative purposes, to convey information (e.g., corporate, regulatory, etc.), or to hide or mask other vehicle components (e.g., adhesives). The black-out layer may be applied to the periphery of the transparent substrate to form a solid masking border or to a portion of the viewing region of the window. This peripheral border may further comprise a fade-out pattern to transition the border into the viewing region of the window. The fade-out pattern may comprise a variety of shapes of variable size including dots, rectangles (lines), squares, and triangles, among others. The black-out layer may further comprise letters, symbols, and numbers including but not limited to corporate logos, trademarks, and regulatory designations.

The polyester resin may be comprised of a single saturated polyester resin type or a mixture of different saturated polyester resins. This polyester resin or resins may be either straight or branch-chained aliphatic or aromatic polymers. These polymers may contain either hydroxyl or carboxyl groups that form films via condensation polymerization with other resins (e.g., amino formaldehyde, melamine, polyisocyanates, etc.) that contain complimentary reactive groups. Saturated polyesters are made from the polymerization of various alcohols (di-, tri- & tetra-hydric alcohols) and acids (or acid anhydrides), such as orthophthalic anhydride, terephthalic acids, and trimellitic anhydride. Most commonly an excess of polyol is used, thereby, providing excess hydroxyl functionality in the final resin. It is known that some polyols, such as 2,2,4-trimethyl, 1,3-pentanediol (TMPD), 1,4-cyclohexane dimethanol (CHDM), neopentyl glycol (NPG), and trimethylol propane (TMP) give more hydrolytically stable systems than do ethylene glycol or glycerol. If excess acid is used as a raw material, the resulting resin will contain carboxylated functionality.

The blackout layer 20 has a predetermined glass transition temperature (Tg). The glass transition temperature of the blackout layer is preferably greater than about 62° C. with greater than about 69° C. being especially preferred. When different polyester resins are blended together in an ink formulation the resulting glass transition temperature of the system should meet the range described above. However, one or more polyesters in the mixture of polyester resins may exhibit an individual Tg value that is outside the specified range. Polyesters can be made from phthalic acid, isophthalic acid, orthophthalic anhydride, tetrahydrophthalic anhydride, hexahydrophthalic anhydride, trimellitic anhydride, succinic anhydride, cyclic polyfunctional carboxylic anhydrides, hexahydrophthalic anhydride (HHPA) and methyl, hexahydrophthalic anhydride and similar such compounds. Typically a blend of resins will result in a Tg_{blend} that is situated between the individual Tg values exhibited by each of the resins present in the blend. This Tg_{blend} is dependent upon the amount of each resin present in the blended ink as shown in Equation 1, where W_{A} and W_{B} are the weight fractions of each polyester resin that individually exhibit a glass transition temperature of Tg_{A} and Tg_{B}, respectively. For a blackout layer comprising a blend of polyester resins, the ratio of 1/Tg_{blend} exhibited by this blend should be less than about 0.002985 with less than about 0.0029239 being especially preferred. T should be in Kelvin.
1/Tg_{blend}=(W_{A}/Tg_{A})+(W_{B}/Tg_{A})

The glass transition temperature (Tg) of an amorphous material generally represents the temperature below which molecules are relatively immobile or have relatively negligible mobility. For polymers, physically, this means that the associated polymeric chains become substantially motionless. In other words, the translational motion of the polymeric backbone, as well as the flexing or uncoiling of polymeric segments is inhibited below the glass transition temperature. On a larger scale, these polymers exhibit a hard or rigid condition. Above its glass transition temperature, these polymers will become more flexible or “rubbery”, thereby exhibiting the capability of larger elastic or plastic deformation without fracture. This transition occurs due to the polymeric chains becoming untangled, gaining more freedom to rotate and slip past each other. The Tg is usually applicable to amorphous phases and is commonly applicable to glasses and plastics. Factors such as heat treatment and molecular re-arrangement, vacancies, induced strain and other factors affecting the condition of a material may affect the Tg. The Tg is dependent on the viscoelastic properties of the material, and thus varies with the rate of applied load.

With polymers, the Tg is often expressed as the temperature at which the Gibb's Free Energy is such that the activation energy for the cooperative movement of about 50 elements of the polymer is exceeded. This allows molecular chains to slide past each other when a force is applied. From this definition, the introduction of side chains and relatively stiff chemical groups (e.g., benzene rings) will interfere with the flowing process and hence increase the Tg. With thermoplastics, the stiffness of the material will drop due to this effect.

The most common method to determine the Tg of a polymeric system is to monitor the variation that occurs in a thermodynamic property, such as modulus, as a function of temperature. As shown in FIG. 2, the modulus (E) of a polymeric material decreases as temperature increases. When the glass transition temperature has been reached, the modulus remains relatively constant until the material begins to flow. The region over which the modulus remains constant is called the “rubber” plateau. Many other means to measure the glass transition temperature of a polymeric material, such as thermal mechanical analysis (TMA) or differential scanning calorimetry (DSC) to name a few, are common analytical methods known to those skilled in the art of polymer synthesis.

The Tg exhibited by a polymer system can be significantly decreased by the addition of a plasticizer into the polymer matrix. The small molecules of the plasticizer may embed themselves between the polymeric chains, thereby, spacing the chains further apart (i.e., increasing the free volume) and allowing them to move against each other more easily.

Placed towards the “A” surface of the plastic panel is a weathering layer 32. This weathering layer 32 may be comprised of but not limited to silicones, polyurethanes, acrylics, polyesters, and epoxies, as well as mixtures or copolymers thereof. The weathering layer preferably includes ultraviolet (UV) absorbing molecules, such as hydroxyphenyltriazine, hydroxybenzophenones, hydroxylphenylbenzotriazoles, hydroxyphenyltriazines, polyaroylresorcinols, and cyanoacrylates among others.

The weathering layer 32 may be comprised of either a single layer or multiple interlayers. One embodiment of multiple interlayers includes a two-interlayer system comprising a primer interlayer 24 and a weatherable interlayer 30 as shown in FIG. 1. The primer interlayer 24 aids in adhering the weatherable interlayer 30 to the second surface 18 of the plastic substrate. The primer interlayer for example may include but not be limited to acrylics, polyesters, epoxies, and copolymers and mixtures thereof. The weatherable interlayer 30 may include, but not be limited to polymethylmethacrylate, polyvinylidene fluoride, polyvinylfluoride, polypropylene, polyethylene, polyurethane, silicone, polymethacrylate, polyacrylate, polyvinylidene fluoride, silicone hardcoat, and mixtures or copolymers thereof. One specific example of a weathering layer comprising multiple coating interlayers includes the combination of an acrylic primer (SHP401, GE Silicones, Waterford, N.Y. ) and a silicone hard-coat (AS4000, GE Silicones).

A variety of additives may be added to the weathering layer 32, such as colorants (tints), rheological control agents, mold release agents, antioxidants, and IR absorbing or reflecting pigments, among others. The weathering layer 32, including any multiple interlayers, may be extruded or cast as thin films or applied as discrete coatings. Any coatings that comprise the weathering layer may be applied by dip coating, flow coating, spray coating, curtain coating, or other techniques known to those skilled in the art.

The plastic glazing system 10 further comprises an abrasion resistant layer 22 disposed on the blackout layer 20 on the first surface 16 of the plastic panel (e.g., towards the “B” or inner surface of the window). The inventors have found that the blackout layer 20 of the present invention is unexpectedly compatible with both the abrasion resistant layer 22 and the plastic substrate 14. That is, the blackout layer 20 adheres to both the abrasion resistant layer 22 and the plastic substrate 14 without the use of any additive layer, e.g., a primer Interlayer.

An abrasion-resistant layer 34 is also applied to the “A” or outer surface of the window on top of the weathering layer 32. The abrasion resistant layer 34 may be substantially similar or different to abrasion resistant layer 22 in either chemical composition or structure. One or both abrasion-resistant layers, 22 & 34, may contain UV absorbing or blocking additives. Both abrasion resistant layers, 22 & 34, may be either comprised of one layer or a combination of multiple interlayers of variable composition. The abrasion-resistant layers, 22 & 34, may be applied by any vacuum deposition technique known to those skilled in the art, including but not limited to plasma-enhanced chemical vapor deposition (PECVD), expanding thermal plasma PECVD, plasma polymerization, photochemical vapor deposition, ion beam deposition, ion plating deposition, cathodic arc deposition, sputtering, evaporation, hollow-cathode activated deposition, magnetron activated deposition, activated reactive evaporation, thermal chemical vapor deposition, and any known sol-gel coating process.

In one embodiment of the present invention a specific type of PECVD process comprising an expanding thermal plasma reactor is preferred. This specific process (called hereafter as an expanding thermal plasma PECVD process) is described in detail in U.S. patent application Ser. No. 10/881,949 (filed Jun. 28, 2004) and U.S. patent application Ser. No. 11/075,343 (filed Mar. 08, 2005), the entirety of both being hereby incorporated by reference. In an expanding thermal plasma PECVD process, a plasma is generated via applying a direct-current (DC) voltage to a cathode that arcs to a corresponding anode plate in an inert gas environment at pressures higher than 150 Torr, e.g., near atmospheric pressure. The near atmospheric thermal plasma then supersonically expands into a plasma treatment chamber in which the process pressure is less than that in the plasma generator, e.g., about 20 to about 100 mTorr.

The reactive reagent for the expanding thermal plasma PECVD process may comprise, for example, octamethylcyclotetrasiloxane (D4), tetramethyldisiloxane (TMDSO), hexamethyldisiloxane (HMDSO), vinyl-D4 or another volatile organosilicon compound. The organosilicon compounds are oxidized, decomposed, and polymerized in the arc plasma deposition equipment, typically in the presence of oxygen and an inert carrier gas, such as argon, to form an abrasion resistant layer.

The abrasion resistant layers, 22 & 34, may be comprised of aluminum oxide, barium fluoride, boron nitride, hafnium oxide, lanthanum fluoride, magnesium fluoride, magnesium oxide, scandium oxide, silicon monoxide, silicon dioxide, silicon nitride, silicon oxy-nitride, silicon oxy-carbide, hydrogenated silicon oxy-carbide, silicon carbide, tantalum oxide, titanium oxide, tin oxide, indium tin oxide, yttrium oxide, zinc oxide, zinc selenide, zinc sulfide, zirconium oxide, zirconium titanate, or a mixture or blend thereof. Preferably, the abrasion resistant layers, 22 & 34, are comprised of a composition ranging from SiOₓ to SiOₓC_{y}H_{z} depending upon the amount of carbon and hydrogen atoms that remain in the deposited layer.

One example of a weatherable layer 32 comprising a primer interlayer 24 and a weatherable interlayer 30 used in conjunction with an abrasion resistant layer 34 is the Exatec® 900 vt glazing system. In the Exatec® 900 vt glazing system, the automotive glazing panel comprises a transparent polycarbonate glazing substrate 14, a weathering layer 32 on the second surface of the substrate (e.g., “A” side of the window) comprising a waterborne acrylic primer 24 (Exatec® SHP 9X, Exatec LLC with GE Silicones) and a silicone hard-coat 30 (Exatec® SHX, Exatec LLC with GE Silicones), and a “glass-like” abrasion resistant layer deposited using an expanding thermal plasma PECVD process. On the first surface of the plastic substrate (e.g., “B” side of the window) the ink of the present invention is printed and cured followed by the deposition of a “glass-like” abrasion resistant layer 22 using an expanding thermal plasma PECVD process

One embodiment of the present invention includes a method of making a plastic glazing system having enhanced yield. In this embodiment, the transparent plastic substrate preferably comprises bisphenol-A polycarbonate and other resin grades (such as branched or substituted) as well as being copolymerized or blended with other polymers such as polybutylene terephthalate (PBT), Poly-(Acrylonitrile Butadiene Styrene (ABS), or polyethylene. The substrate preferably is formed into a window, e.g., vehicle window, from plastic pellets or sheets through the use of any known technique to those skilled in the art, such as extrusion, molding, which includes injection molding, blow molding, and compression molding, or thermoforming, which includes thermal forming, vacuum forming, and cold forming. It is to be noted that the forming of a window using plastic sheet may occur prior to printing, after printing, or after application of the primer and top coat without falling beyond the scope or spirit of the present invention.

In this embodiment, the method further comprises applying the blackout layer on the periphery of the first surface of the substrate. The blackout layer is an ink comprising a polyester resin having a predetermined glass transition temperature with greater than about 62° C. being preferred and greater than about 69° C. being especially preferred. The polyester ink comprises a polyester resin mixture, titanium oxide, carbon black, gamma-butyrolactone, aliphatic dibasic acid ester and colorant pigment dispersed in petroleum distillate, cyclohexanone mixture, and naphthalene. The ink has a thickness greater than about 3 micrometers and an opacity of greater than about 98%.

In this embodiment, the method further comprises drying the blackout layer on the substrate at room temperature for about 20 minutes and curing the blackout layer on the substrate at between about 90 and 100° C. for about 30 minutes.

In this embodiment, the method further comprises applying a weatherable layer to the second surface of the plastic substrate using a flow, dip, or spray coating process. The weatherable layer may include first the application of a primer interlayer followed by the drying of the primer interlayer on the substrate at room temperature for about 20 minutes and subsequently curing the primer on the substrate at between about 120 and 130° C. for about 30 minutes.

The method further comprises applying a weatherable interlayer on the primer interlayer for enhanced weatherability. In this example, the weatherable interlayer is a silicone hard-coat including UV absorbing molecules.

In this embodiment, the method further includes applying abrasion resistant layers on top of the blackout layer and the weatherable layer, respectively. The abrasion resistant layers are comprised of a composition ranging from SiOₓ to SiOₓC_{y}H_{z}. The abrasion resistant layers are deposited using plasma-enhanced chemical vapor deposition (PECVD), expanding thermal plasma PECVD, plasma polymerization, photochemical vapor deposition, ion beam deposition, ion plating deposition, cathodic arc deposition, sputtering, evaporation, hollow-cathode activated deposition, magnetron activated deposition, activated reactive evaporation, thermal chemical vapor deposition, and any known sol-gel coating process with the expanding thermal plasma PECVD process being preferred.

### EXAMPLE 1

Test results obtained by the inventors for substrates with a decorative black-out layer having a high Tg are provided in Table 1. More specifically, Table 1 provides adhesion retention data obtained for different ink formulations applied to and cured on a polycarbonate and subsequently coated with the Exatec® 900 vt glazing system. The adhesion test is known to those skilled in the art of automotive adhesive bonding as the “Cataplasma” test. The protocol associated with this “Cataplasma” test is adequately described in U.S. Pat. No. 6,958,189 (2005) which is hereby incorporated by reference in its entirety.

The adhesive system applied to the printed and coated plastic glazing system consists of a silicone coupling agent (Betaseal 53520, Dow Essex, Michigan), an urethane primer (Betaseal 48520A, Dow Essex), and an urethane adhesive (Betaseal 57302 Dow Essex). The adhesive system is applied as a bead to the printed ink/coating and cured for 96 hours at room temperature (about 23° C.) according to the manufacturer's recommended conditions. After the adhesive system is cured, the printed and coated substrate to high humidity at an elevated temperature followed by a low temperature shock (i.e., wrapping the system for 7 days in wet cotton at 70° C. followed by 3 hrs at -20° C.). After being equilibrated at room temperature (about 23° C.) the polycarbonate substrate with the printed ink is subjected to a visual inspection for optical changes or defects, such as the development of haze, color change, blisters, microcracks, etc., as well a cross-hatch adhesion test performed according to ASTM protocol D3359-95.

Upon completion of the Cataplasma test conditions, the adhesive is peeled from the printed/coated substrate. The resulting bonding performance of the urethane adhesive is then determined upon pulling the bead away from the coated plaque. The degree to which the failure mechanism observed reflects the cohesive failure of the urethane adhesive (e.g., adhesive bead breaks or splits) is then determined. In the following table each ink (Run #'s 1-4) passed the test by exhibiting a rating greater or equal to 80% cohesive failure.

TABLE 1

| | | Tg | Ink |
|---|---|---|---|
| | | (° C.) | Cracking |
| Run 1 | 8452 Polyester Ink (89.4 wt %), RE196 | 45 | heavy |
| | Retarder (7 wt %), L67BA Cross-Linker | | |
| | (3.6 wt %) - [Nazdar Inc, Kansas] | | |
| Run 2 | TB05018 Polyester Ink (89.4 wt %), RE196 | 50 | medium |
| | Retarder (7 wt %), L67BA Cross-Linker | | |
| | (3.6 wt %) - [Nazdar Inc, Kansas] | | |
| Run 3 | TB05038 Polyester Ink (89.4 wt %), RE196 | 69 | None |
| | Retarder (7 wt %), L67BA Cross-Linker | | |
| | (3.6 wt %) - [Nazdar Inc, Kansas] | | |
| Run 4 | TB05038 Polyester Ink (89.4 wt %), RE196 | 69 | mild |
| | Retarder (7 wt %), L67BA Cross-Linker | | |
| | (7.2 wt %) - [Nazdar Inc, Kansas] | | |

However, all printed ink mixtures having a glass transition temperature less than about 62° C. (Run #'s 1-2) suffer from a substantial amount of fracturing or cracking of the ink under the Cataplasma test conditions. In Run #1, the polyester ink is a mixture or blend of two polyester resins both exhibiting individual Tg values below 62° C. The polyester ink in Run #2 represented an ink comprising a single polyester resin type with a Tg of 50° C.

No cracking was observed in the printed polyester ink having a glass transition temperature of 69° C. (Run #3). The polyester ink in Run #3 represents an ink also comprising a single polyester resin type. The printed ink in Run #4 having the same polyester resin (e.g., same Tg=69° C.) as used in Run #3, but with a much higher crosslink density (e.g., more Cross-Linker used), is found to exhibit some mild cracking. Thus the cross-link density may affect the initiation of this cracking phenomenon. This example demonstrates that in order not to exhibit a substantial defect due to the cracking of the printed ink, the ink should exhibit a glass transition temperature greater than about 62° C. with greater than about 69° C. being preferred.

### EXAMPLE 2

Based on the results obtained in Example 1, the substrates comprising the printed ink described by Run #3 coated with the Exatec® 900 vt glazing system were evaluated in a harsh thermal cycling test. Table 2 provides the adhesion data obtained after thermal cycling using an automotive OEM test condition (PSA Peugot Citroen, D47-1309) consisting of 15 total cycles with each cycle comprising the exposure of the test substrate to a different temperature & relative humidity (RH) condition for a specified time interval. The different temperature, RH, and time interval conditions included in this test are 40° C. & 50% RH for 30 minutes, 40° C. & 50% RH for 2.5 hours, −20° C. for 30 minutes, −20° C. for 2.5 hours, 40° C. 795% 45 minutes, 40° C. & 95% RH for 2.5 hours, 90° C. for 15 minutes, and 90° C. for 2.5 hours. Upon completion of the thermal cycling portion of the test a simple scribed (e.g., cross-hatch) tape-pull according to ASTM protocol D3359-95 is used to determine the occurrence of coating delamination. A substrate passes the test when no coating delamination and no cracks are observed. The test was performed on six substrates (A-F) comprising the ink and glazing system described for Run #3.

TABLE 2

| | Adhesion Retention (%) | Cracks |
|---|---|---|
| Run 3-A | >99% | None |
| Run 3-B | >99% | None |
| Run 3-C | >99% | None |
| Run 3-D | >99% | None |
| Run 3-E | >99% | None |
| Run 3-F | >99% | None |

No coating delamination or cracking of the ink was observed in all six trials (A-F). Thus the polyester ink formulation with a Tg greater than about 69° C. is found to pass this thermal cycling test.

While the present invention has been described in terms of preferred embodiments, it will be understood, of course, that the invention is not limited thereto since modifications may be made to those skilled in the art, particularly in light of the foregoing teachings.

1. A plastic glazing system for automotive windows, the system comprising:
a transparent plastic substrate comprising a first surface and a second surface;
a blackout layer disposed on the periphery of the first surface of the substrate, the blackout layer having a predetermined glass transition temperature; and
an abrasion-resistant layer disposed on the first surface, the abrasion-resistant layer being compatible with the blackout layer.

2. The system of claim 1 wherein the blackout layer is an ink comprising a polyester resin.

3. The system of claim 2 wherein the polyester ink comprises a polyester resin mixture, titanium oxide, carbon black, gamma-butyrolactone, aliphatic dibasic acid ester and colorant pigment dispersed in petroleum distillate, cyclohexanone mixture, and naphthalene.

4. The system of claim 1 wherein the blackout layer has a glass transition temperature greater than about 62 degrees Celsius.

5. The system of claim 4 wherein the blackout layer has a glass transition temperature greater than about 69 degrees Celsius.

6. The system of claim 1 wherein the blackout layer comprises a mixture of resins whose sum of W/Tg ratios is less than about 0.002985.

7. The system of claim 6 wherein the blackout layer comprises a mixture of resins whose sum of W/Tg ratios is less than about 0.0029239.

8. The system of claim 1 further comprising:
a weathering layer deposited on the second surface; and
an abrasion-resistant layer deposited on the weathering layer.

9. The system of claim 8 wherein the weathering layer is comprised of a primer interlayer disposed on the second surface to aid in the adhesion of a weathering interlayer disposed on the primer interlayer.

10. The system of claim 8 wherein the abrasion-resistant layer deposited on the weathering layer is substantially similar to the abrasion-resistant layer deposited on the blackout layer.

11. The system of claim 8 wherein the weathering layer comprises an ultraviolet absorbing molecule for absorption of UV radiation.

12. The system of claim 9 wherein at least one of the primer interlayer and the weathering interlayer comprises an ultraviolet absorber for absorption of UV radiation.

13. The system of claim 1 wherein the transparent plastic substrate comprises one of a polycarbonate resin, acrylic resin, polyacrylate resin, polyester resin, polysulfone resin, and copolymers or mixtures thereof.

14. The system of claim 1 wherein the abrasion resistant layer applied on to the black-out layer comprises aluminum oxide, barium fluoride, boron nitride, hafnium oxide, lanthanum fluoride, magnesium fluoride, magnesium oxide, scandium oxide, silicon monoxide, silicon dioxide, silicon nitride, silicon oxy-nitride, silicon oxy-carbide, hydrogenated silicono oxy-carbide, silicon carbide, tantalum oxide, titanium oxide, tin oxide, indium tin oxide, yttrium oxide, zinc oxide, zinc selenide, zinc sulfide, zirconium oxide, zirconium titanate, or a mixture thereof.

15. The system of claim 8 wherein the abrasion resistant layer applied on to the weathering layer comprises aluminum oxide, barium fluoride, boron nitride, hafnium oxide, lanthanum fluoride, magnesium fluoride, magnesium oxide, scandium oxide, silicon monoxide, silicon dioxide, silicon nitride, silicon oxy-nitride, silicon oxy-carbide, hydrogenated silicono oxy-carbide, silicon carbide, tantalum oxide, titanium oxide, tin oxide, indium tin oxide, yttrium oxide, zinc oxide, zinc selenide, zinc sulfide, zirconium oxide, zirconium titanate, or a mixture thereof.

16. The system of claim 9 wherein the primer interlayer comprises one of an acrylic, polyester, epoxy, or copolymers and mixtures thereof.

17. The system of claim 9 wherein the weatherable interlayer comprises one of polymethylmethacrylate, polyvinylidene fluoride, polyvinylfluoride, polypropylene, polyethylene, polyurethane, silicone, polymethacrylate, polyacrylate, polyvinylidene fluoride, silicone hardcoat, and mixtures or copolymers thereof.

18. The system of claim 1 wherein the ink has a thickness of greater than about 3 micrometers.

19. The system of claim 1 wherein the ink has an opacity of greater than about 98% in order to mask the bonding system.

20. The system of claim 19 wherein the ink has an opacity between about 99.8% to 100.0%.

21. A method of making a plastic glazing system, the method comprising:
applying a blackout layer on the periphery of a transparent plastic substrate, the blackout layer having a predetermined glass transition temperature; and
applying an abrasion-resistant layer disposed on the blackout layer, the abrasion-resistant layer being compatible with the blackout layer.

22. The method of claim 21 further comprising:
applying a weathering layer on the transparent plastic substrate opposite the blackout layer; and
applying an abrasion-resistant layer on the weathering layer.

23. The method of claim 21 wherein the blackout layer is an ink comprising a polyester resin.

24. The method of claim 23 wherein the polyester ink comprises a polyester resin mixture, titanium oxide, carbon black, gamma-butyrolactone, aliphatic dibasic acid ester and colorant pigment dispersed in petroleum distillate, cyclohexanone mixture, and naphthalene.

25. The method of claim 21 wherein the blackout layer has a glass transition temperature greater than about 62 degrees Celsius.

26. The method of claim 25 wherein the blackout layer has a glass transition temperature greater than about 69 degrees Celsius.

27. The method of claim 21 wherein the blackout layer comprises a mixture of resins whose sum of W/Tg ratios is less than about 0.002985.

28. The method of claim 27 wherein the blackout layer comprises a mixture of resins whose sum of W/Tg ratios is less than about 0.0029239.

29. The method of claim 21 wherein the abrasion-resistant layers are deposited.using a method selected as one of plasma-enhanced chemical vapor deposition (PECVD), expanding thermal plasma PECVD, plasma polymerization, photochemical vapor deposition, ion beam deposition, ion plating deposition, cathodic arc deposition, sputtering, evaporation, hollow-cathode activated deposition, magnetron activated deposition, activated reactive evaporation, thermal chemical vapor deposition, or any known sol-gel coating processes.

30. The method of claim 29, wherein the abrasion-resistant layers are deposited using an expanding thermal plasma PECVD process.

31. The method of claim 21 wherein the transparent plastic substrate comprises one of a plastic glazing resin, acrylic resin, polyacrylate resin, polyester resin, polysulfone resin, and copolymers or mixtures thereof.

32. The method of claim 21 wherein the ink has a thickness of greater than about 3 microns.

33. The method of claim 21 wherein the ink has an opacity of greater than about 98% in order to mask the bonding system.
